(19) United States
(12) Patent Application Publication
(10) Pub. No.: US 2008/0109630 A1
(43) Pub. Date: May 8, 2008

(54) Storage system, storage unit, and storage management system

(75) Inventors: Yuki Watanabe, Yokohama (JP); Nobuo Beniyama, Yokohama (JP); Takuya Okamoto, Machida (JP); Takaki Kuroda, Machida (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/639,145

(22) Filed: Dec. 15, 2006

(30) Foreign Application Priority Data
Nov. 2, 2006 (JP) 2006-298408

(51) Int. Cl. G06F 12/02

(52) U.S. Cl. 711/171; 711/E12.002

(57) ABSTRACT

In a storage system, to allocate a physical storage area to the storage system in response to a new write request issued thereto, an appropriate allocation size is obtained according to write requests issued in the past. If the allocation size obtained as a result has been defined in the storage unit, the setting information of the storage unit is changed to allocate the physical storage area of the allocation size to the storage unit.

### INCORPORATION BY REFERENCE

The present application claims priority from Japanese application JP2006-298408 filed on Nov. 2, 2006, the content of which is hereby incorporated by reference into this application.

### BACKGROUND OF THE INVENTION

The present invention relates to a storage unit and a method of managing the storage, and in particular, to allocation of physical storage areas to logical storage areas.

Recently, systems in which storage units or apparatuses are connected via a network to host computers have been increasingly installed. The host computer includes various applications for jobs. To actually conduct a job, it is required to allocate storage areas of the storage units to each application for use thereof.

However, it is difficult to predict the capacity of the storage areas required by the application, and hence the storage areas cannot be appropriately allocated. Therefore, even if predicted storage areas are allocated to an application, there likely occur disadvantageous situations depending on the state of operation of the application, for example, a situation in which many storage areas remain unused due to a small amount of data write requests and a situation in which the capacity of the storage areas is insufficient due to a large number of data write requests.

To remove the problem, for example, U.S. Patent Application Publication No. US 2004/0039875 describes a technique in which logical storage areas are provided to the application by use of a scheme called virtualization. When a data write request occurs for the logical storage areas, physical storage areas of a fixed size are allocated to the logical storage areas.

### SUMMARY OF THE INVENTION

As above, fixed-size physical storage areas are allocated to logical storage areas using the virtualization, and hence resources of a storage medium such as a disk device can be efficiently used.

However, the storage units are connected to a plurality of host computers and a plurality of applications are executed. The write or read data items have various data sizes depending on applications, and the data access frequency also varies between applications.

Therefore, if the physical storage area is smaller in size than the data for the reading or writing operation, a plurality of physical storage areas are selected for the reading or writing requests and hence the read/write efficiency is lowered. On the other hand, in a case in which the physical storage area is larger in size than the data, if the data writing request occurs at random, the number of unused areas increases.

It is therefore an object of the present invention to provide a storage unit and a storage system which make it possible to improve the utilization ratio of physical storage areas of the storage unit and in which the storage areas are efficiently secured.

The storage unit allocates physical storage areas in response to a data write request from a host computer to write data in virtual storage areas.

Physical storage areas of mutually different sizes are disposed in the storage units such that a management server managing the storage collects access information for virtual storage areas. According to the collected access information, the management server determines a physical storage area of an appropriate allocation size to allocate the physical storage area of the size determined in the storage unit.

It is therefore possible to provide a storage unit and a storage system capable of improving the utilization ratio of the physical storage areas.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of an embodiment of a storage system according to the present invention.

FIG. 2 is a diagram showing a storage layout of a storage unit.

FIG. 3 is a flowchart showing processing to collect access information of an application.

FIG. 4 is a diagram showing a pool mapping management table.

FIG. 5 is a diagram showing a pool definition management table.

FIG. 6 is a diagram showing a address mapping management table.

FIG. 7 is a flowchart showing read/write processing in the storage unit.

FIG. 8 is a flowchart showing data transfer processing to the storage unit.

FIG. 9 is a diagram showing an application management table.

FIG. 10 is a diagram showing an access history management table.

FIG. 11 is a diagram showing a pool management table.

FIG. 12 is a diagram showing a virtual volume management table.

FIG. 13 is a diagram showing a Logical Device (LDEV) management table.

FIG. 14 is a diagram showing a storage area management table.

FIG. 15 is a diagram showing a fitness judging object management table.

FIG. 16 is a diagram showing an allocation information management table.

FIG. 17 is a diagram showing a data transfer management table.

FIG. 18A is a flowchart showing processing to define a virtual volume.

FIG. 18B is a flowchart showing processing to define a virtual volume.

FIG. 19 is a diagram showing an input screen to define a virtual volume.

FIG. 20 is a flowchart showing processing to determine a segment size for virtual volume allocation.

FIGS. 21A and 21B are diagrams showing an outline of processing to identify a new write request.

FIGS. 22A and 22B are diagrams showing an outline of processing to obtain allocation information.

FIG. 23 is a flowchart showing processing to determine availability of segments of the determined size.

FIG. 24 is a flowchart showing processing to define the segments of the determined size in the storage unit.

FIG. 25 is a flowchart showing data transfer processing.

FIG. 26 is a block diagram showing a configuration of another embodiment of a storage system according to the present invention.

### DESCRIPTION OF THE EMBODIMENTS

Referring to the drawings, description will be given of embodiments of the present invention.

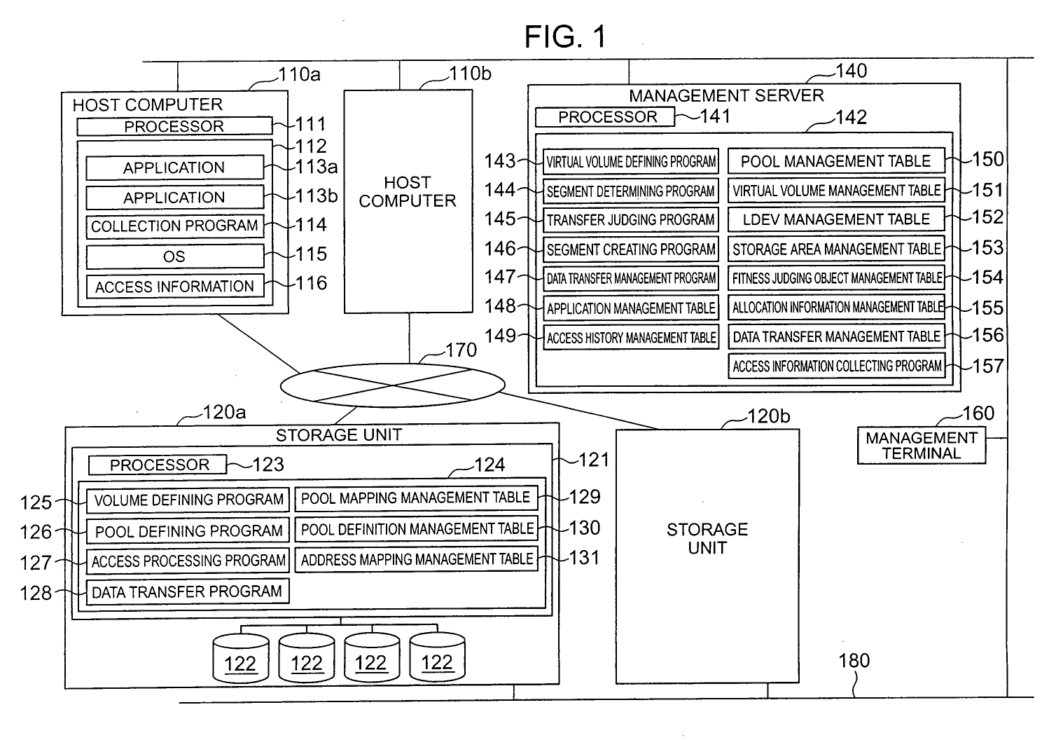

FIG. 1 shows a configuration of an embodiment of a storage system according to the present invention.

The system includes a plurality of host computers 110a and 110b (to be representatively indicated by 110 hereinbelow), a plurality of storage units 120a and 120b (to be representatively indicated by 120 hereinbelow), a management server 140, and a management terminal 160. The host computers 110 are connected via a first network 170 to the storage units 120. The host computers 110, the storage units 120, the management server 140, and the management terminal 160 are connected via a second network 180 to each other. The first and second networks 170 and 180 may be of any types of networks. For example, a Storage Area Network (SAN) may be employed as the first network and a Local Area Network (LAN) may be used as the second network.

The host computer 110 includes a memory 112 to store programs and data and a processor 111, for example, a Central Processing Unit (CPU) to execute the programs stored in the memory 112. The memory 112 of the host computer 110 stores an application program 113 to conduct jobs, a collection program 114 to collect access information of the application program 113, an Operating System (OS) 115, and access information 116.

The storage unit 120 includes a controller or a control unit 121 and a plurality of disk devices 122. In the embodiment, disk devices are employed as physical storage media. However, there may also be employed a semiconductor storage unit such as a flash memory and a combination of disk devices and semiconductor storage units. Therefore, even if “disk device” in the description below is replaced by “semiconductor storage”, no problem occurs in the implementation of the system.

The controller 121 includes a memory 124 to store programs and data and a processor 123 which executes the programs stored in the memory 124 and which controls data transfer between the host computer 110 and the disk devices 122. The memory 124 of the controller 121 stores a virtual volume defining program 125, a pool defining program 126, an access processing program 127, a data transfer program 128, a pool mapping management table 129, a pool definition management table 130, and an address mapping management table 131. Processing of each program will be described later in detail.

The controller 121 may be configured in another way. For example, the controller 121 may include a plurality of processors and cache memories. The storage units 120a and 120b may be equal to each other or different from each other in the hardware configuration.

The management server 140 includes a memory 142 to store programs and data and a processor 141 to execute the programs stored in the memory 142. The memory 142 stores a virtual volume defining program 143, a segment determining program 144, a transfer judging program 145, a segment creating program 146, a data transfer management program 147, an application management table 148, an access history management table 149, a pool management table 150, a virtual volume management table 151, an LDEV management table 152, a storage area management table 153, a fitness judging object management table 154, an allocation information management table 155, a data transfer management table 156, and an access information collecting program 157.

The management terminal 160 includes a processor, a memory, an input device such as a keyboard and a mouse, and a display. The terminal 160 is connected via the second network 180 to the management server 140. Input information is sent from the terminal 160 to the server 140. Execution results of various programs of the server 140 are displayed on the display of the terminal 160.

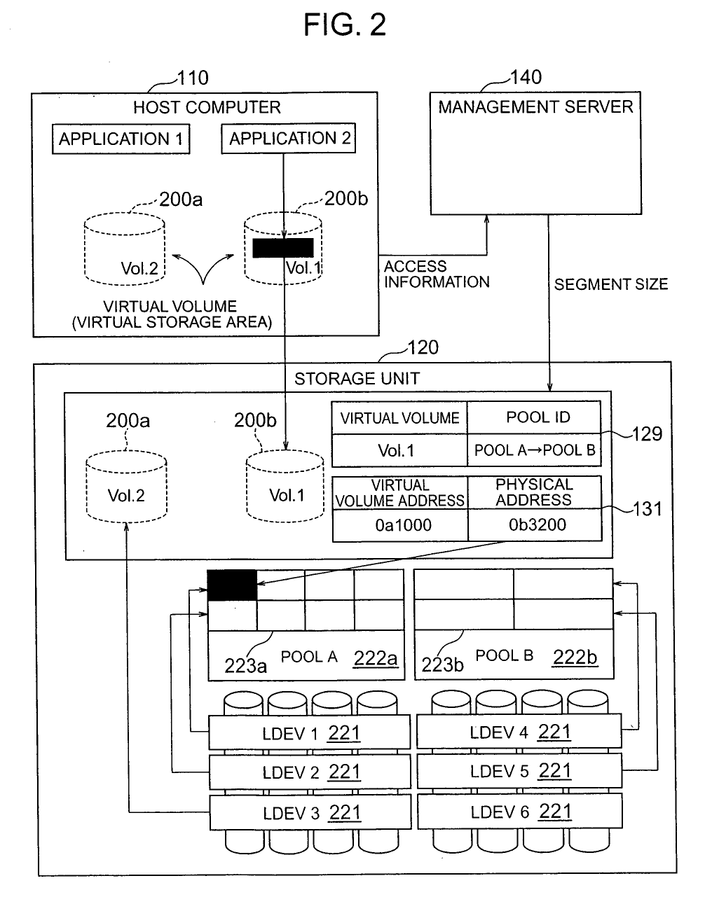

FIG. 2 shows a storage configuration of the storage system.

The host computer 110 is provided with virtual volumes 200 (virtual volumes 200a and 200b) as logical storage areas by the operating system. The application 113 conducts data write and read operations for the virtual volumes 200.

The storage unit 120 may be installed in a Redundant Arrays of Inexpensive Disks (RAID) configuration in which a predetermined number of disk devices are classified into groups including, for example, four disk devices (3D+1P) or eight disk devices (7D+1P). The storage areas of the groups are subdivided into logical areas, i.e., Logical Devices (LDEV) 211 to be respectively allocated to the pools 222. In each pool 222, the logical areas of LDEV is further subdivided into storage areas, i.e., segments 223 for the management thereof. The size of the segments 223 may be set for each pool. For example, it is possible that the segment is 25 MegaBytes (MB) for the pool A 222a and 50 MB for the pool B 222b. Although the LDEVs of the storage unit are allocated to the pools in this configuration, it is also possible to allocate LDEVs of another storage unit to the pools.

In the configuration, no segment has been allocated to the virtual volume 200b in the initial state. That is, no physical storage area has been allocated thereto. Therefore, if an access request addressed to the virtual volume 200b is received, the controller 121 of the storage unit 120 allocates segments to the virtual volume 200b to store data in the allocated segments. Specifically, at reception of the write request for the virtual volume 200b, the controller 21 refers to the address mapping management table 131. If no segment has been allocated to addresses of the virtual volume 200b, the controller 21 refers to the pool mapping management table 129 and allocates segments of a pool defined for a virtual volume to the virtual volume 200b to thereby write data in the allocated segments. In this way, through the segment allocation, the physical storage areas are additionally increased in the virtual volume 200b. This enables an efficient use of the physical storage areas. In the description below, such virtual volume will be referred to as “additional-type virtual volume” or “virtual volume of additional-type”.

For the storage unit 120, it is possible to define, without adding physical storage areas as above, virtual volumes to which physical storage areas are allocated in advance, the virtual volumes being almost equal in the size to that of the physical storage areas. The virtual volume 200a is an example of a virtual volume of this kind. The allocated LDEVs are almost equal in the size to the virtual volume. In this connection, a plurality of LDEVs may be allocated to one virtual volume. In the following description, such virtual volume is referred to as “fixed-type virtual volume” or “virtual volume of fixed type”.

It is also possible to beforehand allocate several segments or several LDEVs to part of the areas of the additional-type virtual volume.

The management server 140 collects access information of the host computer 110 to determine segments of a size suitable to allocate the segments to the additional-type virtual volume. To enable the allocation of the segments having the determined size, the management server 140 changes the pool mapping management table 129 of the storage unit 120. For example, as shown in FIG. 2, if a write request is addressed to the virtual volume 200b to which segments of pool A are allocated and the write data-size is larger than that of pool A, the management server 140 instructs to change the pool mapping management table 129 to allocate segments of pool B to the virtual volume 200b. As a result, the allocation count indicating the number of allocation for the write request is reduced and hence the operation efficiency is improved. On the other hand, if the write data size is smaller than that of pool A, the resource use efficiency is improved by modifying the table 129 to allocate segments of pool A to the virtual volume 200b.

Next, description will be given of each processing described in conjunction with FIG. 2.

First, the processing of the host computer 110 will be described.

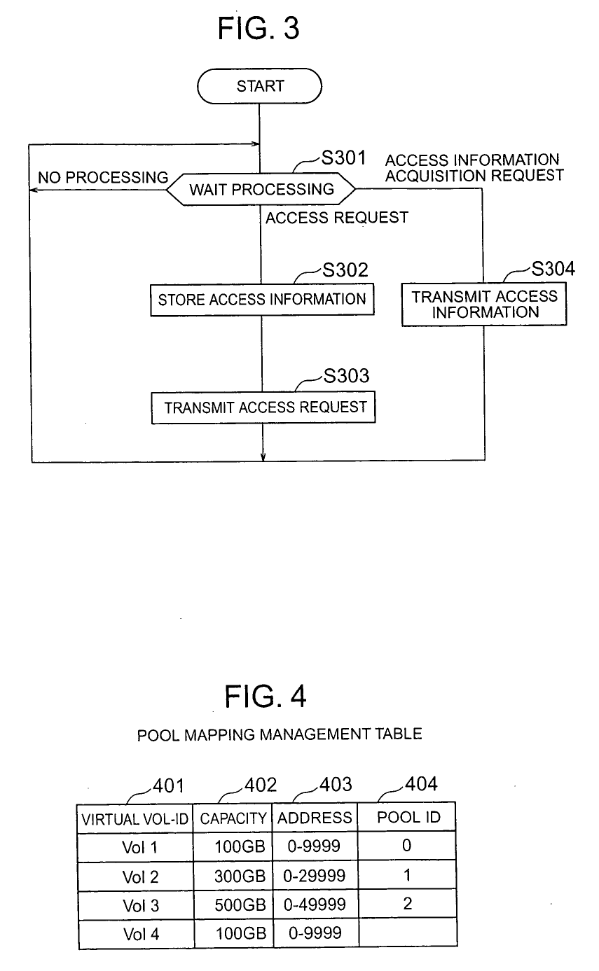

FIG. 3 shows processing to collect access information.

The processing is executed by the collection program 114 of the host computer 110 and is initiated at execution of either one of the application programs 113.

The collection program 114 awaits an access request from an application program 113 or an acquisition request from the management server 140 (“no processing” in step S301). If an access request is received from the application program 113 (“access request” in step S301), the collection program 114 stores an identifier of a virtual volume, a type “read request” or “write request”, an address, and a data size contained in the request in the memory 112 together with an application name and information of time (step S302). If the access request is a read request, the data size is obtained using a response to the read request. The collection program 114 sends the access request to the storage unit 120 (step S303) and then returns to step S301. If an acquisition request is received from the management server 140 (“access information acquisition request” in step S301), the collection program 114 sends access information from the memory 12 to the management server 140 (step S304).

In this regard, the collection program 140 may be incorporated in the operating system 115 of the host computer 110.

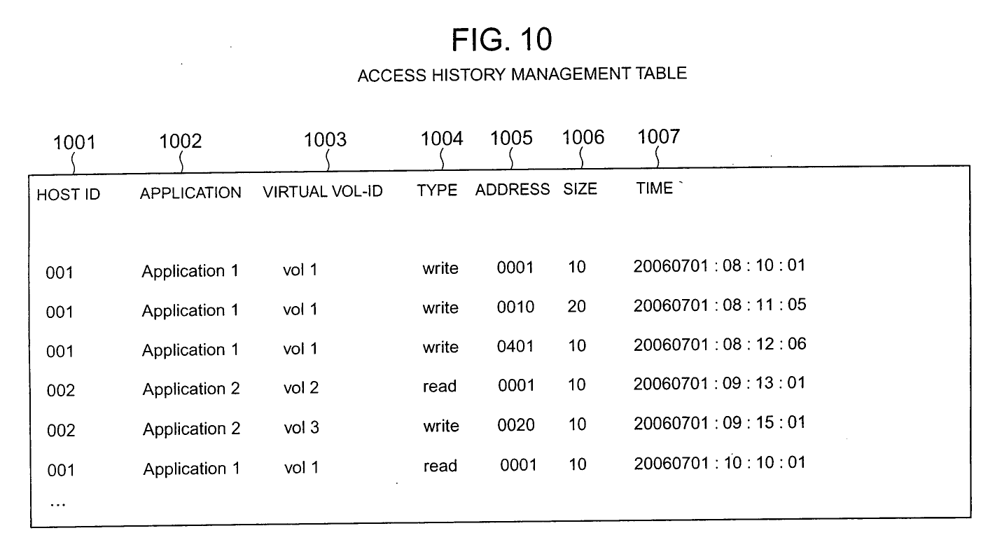

FIG. 10 shows the access information collected by the management server 140. The data items excepting the host identifier (ID) are collected by the collection program 114.

Next, the storage unit 120 will be described.

First, description will be given of information managed by the storage unit 120.

FIG. 4 shows the pool mapping management table 129.

In the table 129, each entry stores a virtual volume identifier (Vol-ID) 401, a virtual volume capacity 402, a virtual volume address (a first address and a last address) 403, a pool identifier (ID) 404. At occurrence of a write request for a virtual volume, if no segment has been allocated thereto, the controller 121 identifies a pool using the table 129.

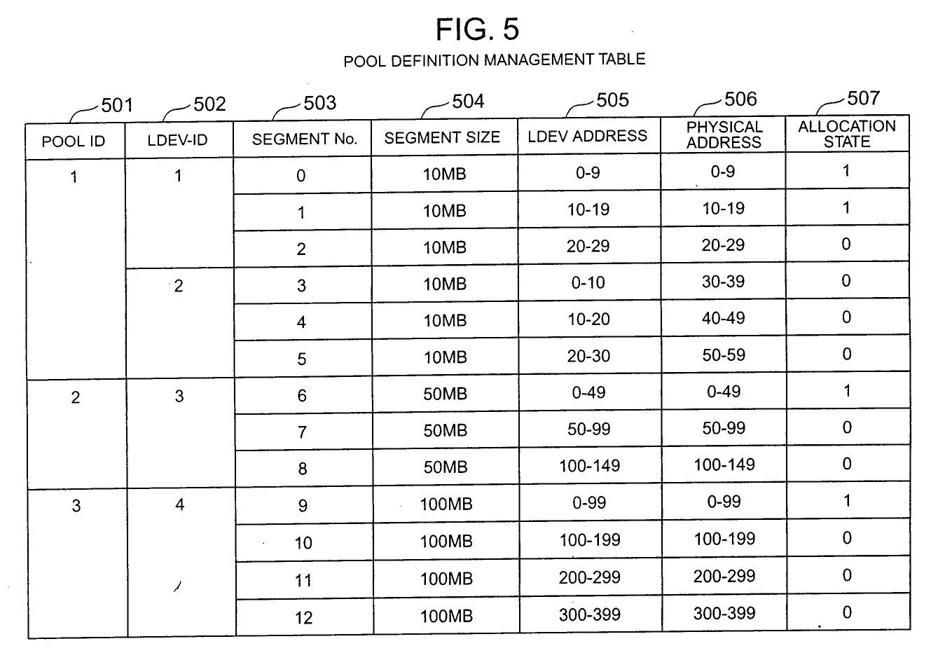

FIG. 5 shows the pool definition management table 130.

Each entry of the table 130 includes a pool identifier 501, an LDEV identifier (LDEV-ID) 502, a segment number 503, a segment size 504, an LDEV address 505, a physical address 506, and an allocation state 507. The segment number 503 is used to identify the pertinent segment and is a unique number in the storage unit 121. The LDEV address 505 indicates a zone of addresses ranging from the first address to the last address assigned at allocation of LDEVs to the segments. The physical address 506 indicates an address of the disk device. In the allocation state 507, “1” indicates allocation to a virtual volume and “0” indicates no allocation. By setting an LDEV of a second storage unit to the LDEV identifier 502, physical storage areas of the second storage unit are allocated to the virtual volume.

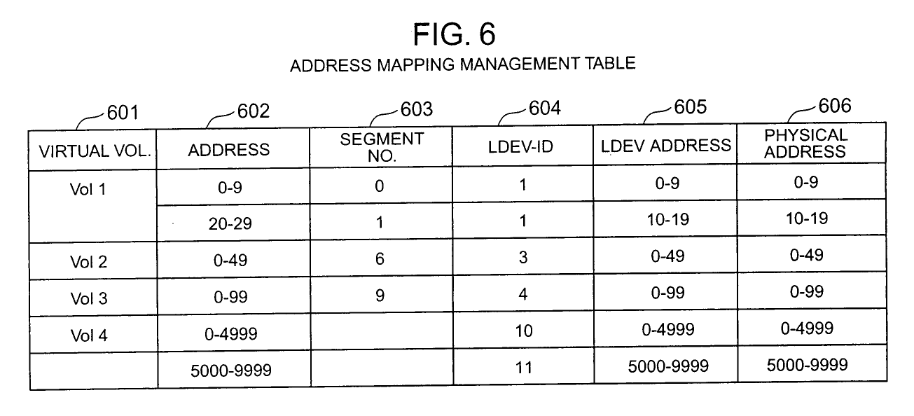

FIG. 6 shows the address mapping management table 131.

Each entry of the table 131 includes a virtual volume identifier 601, a virtual volume address 602, a segment number 603, an LDEV identifier 604, an LDEV address 605, and a physical address 606. For the volumes 1 to 3, segments and physical addresses are set to part of the virtual volumes, and hence these volumes are volumes of additional-type. For the volume 4, LDEVs and physical addresses are set to all addresses of the virtual volume, and hence the volume 4 is a volume of fixed type.

Next, description will be given of processing of the storage unit 121.

The volume defining program 125 of the storage unit 121 sets and modifies or changes the pool mapping table 129 and the address mapping management table 131 in response to requests from the management server 140. For the additional-type virtual volume, the server 140 sends virtual volume defining information including a virtual volume identifier, a capacity, and a pool identifier. The volume defining program 125 then sets the virtual volume identifier, the capacity, and the pool identifier to the pool mapping management table 129. The program 125 obtains associated addresses using the capacity and stores the addresses in the table 129. The program 125 further sets the virtual volume identifier to the address mapping management table 131. For the fixed-type virtual volume, the program 125 receives a virtual volume identifier, a capacity, and an LDEV identifier. The program 125 the virtual volume identifier, the capacity, and an address obtained using the capacity sets to the pool mapping management table 129. The program 125 further sets the virtual volume identifier, the address, the LDEV identifier, an LDEV address, and a physical address to the address mapping management table 131. As a result, the additional-type and fixed-type virtual volumes are defined.

The volume defining program 125 also receives pool allocation change information from the management server 140. The information includes a virtual volume identifier and a pool identifier. The program 125 replaces the pool identifier for the beforehand set virtual volume by the pool identifier contained in the information. If such pool allocation change information for an additional-type virtual volume is received, other segments are allocated to the volume, beginning at the point of time when the information is received. That is, segments of the different size are allocated to one and the same additional-type virtual volume.

The pool defining program 126 defines a pool according to pool defining information sent from the management server 140. To define a new pool, the server 140 sends pool defining information including a pool identifier, a segment size, and an LDEV identifier. When these items are received, the program 126 divides the designated LDEV by the segment size to set the pool identifier, the LDEV identifier, a segment number, the segment size, an LDEV address, and a physical address to the pool definition management table 130. If pool additional information including a pool identifier and an LDEV identifier is received from the management server 140, the program 126 divides the designated LDEV by a segment size determined according to the pool identifier to thereby set the LDEV identifier, a segment number, the segment size, an LDEV address, and a physical address to the pool definition management table 130.

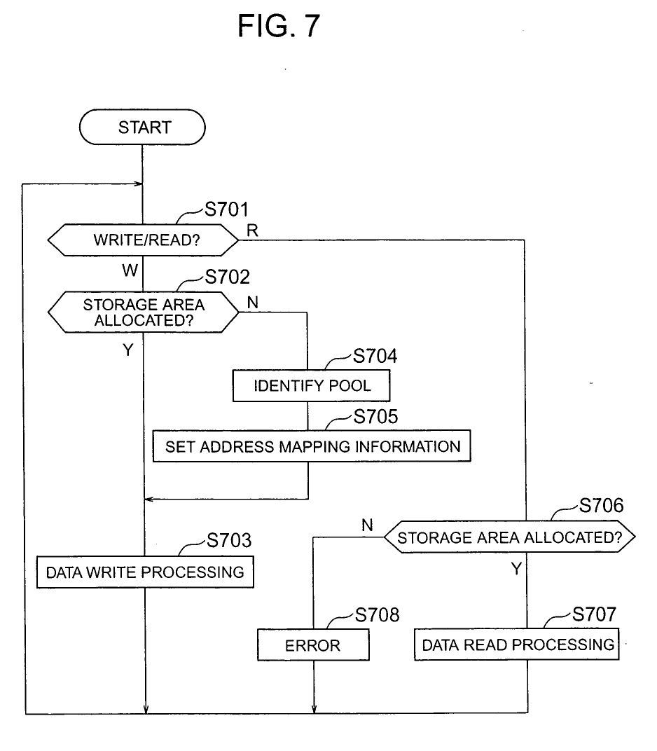

FIG. 7 shows processing of an access request in the storage unit.

The processing is executed by the access processing program.

If the access request is a write request (“W” in step S701), the program determines whether or not a storage area (a segment or an LDEV) has been allocated, according to the address mapping management table 131 (step S702). If the storage area has been allocated (“Y” in step S702), the program executes processing to write data in the storage area (step S703). On the other hand, if the storage area has not been allocated (“N” in step S702), the program identifies a pool identifier corresponding to a virtual volume using the pool mapping management table 129 (step S704). Next, according to the pool definition management table 130, the program identifies an unallocated segment using the pool identifier to set “1” to the allocation state of the segment. The program then sets an address of the virtual volume, a segment number, an LDEV identifier, an LDEV address, and a physical address to the address mapping management table 131 (step S705). Thereafter, the program executes the write processing (step S703).

If the access request is a read request (“R” in step S701), the program determines whether or not a storage area has been allocated, according to the address mapping management table 131 (step S706). The determination processing of the step S706 is almost equal to that of step S702. If it is determined that the storage area has been allocated (“Y” in step S706), the program executes data read processing (step S707). Otherwise (“N” in step S706), an error is assumed (step S708).

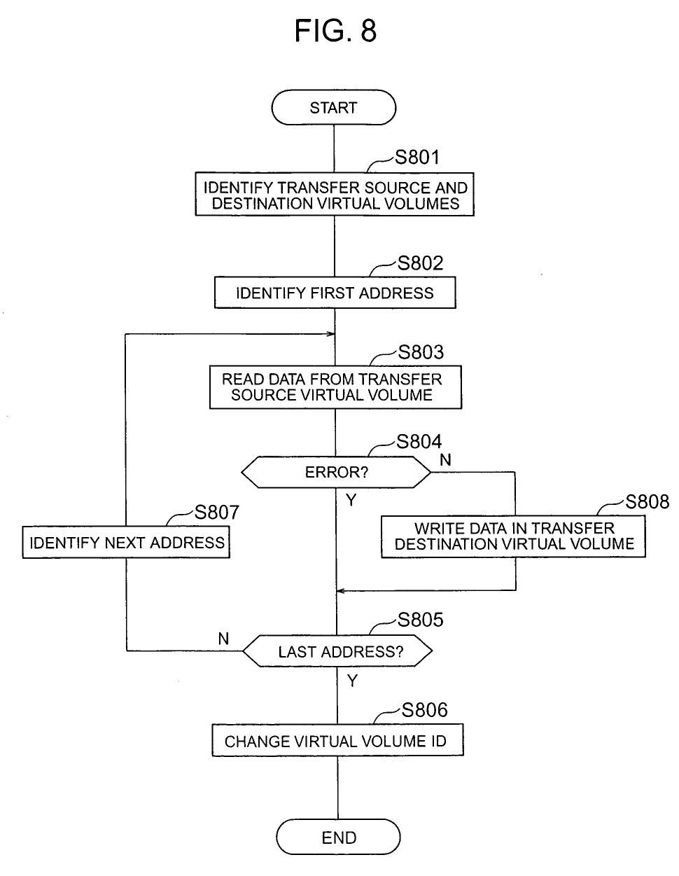

FIG. 8 shows processing to transfer data between virtual volumes.

The processing is executed by the data transfer program 128 in response to a data transfer instruction from the management server 140. In the processing, the program accesses a virtual volume designated as a transfer source to read data stored in a range from the first address to the last address of the volume. The program then writes the data in a virtual volume designated as a transfer destination volume using the first and last addresses.

The management server 140 sends information including the transfer source and destination virtual volumes and a transfer indication.

According to the information, the program identifies the source and destination virtual volumes (step S801). Using the address mapping management table 131, the program determines a first address of the source volume (step S802). The program then conducts a data read operation using the address (step S803). The read operation is conducted according to the processing shown in FIG. 7. A check is made for the read result (step S804). If an error is assumed (“Y” in step S804), a check is made to determine whether or not the current address is the last address (step S805). If the address is other than the last address, the program identifies the next address (step S807) and continuously executes processing beginning at step S803. Otherwise (“N” in step S804), the data is written in the destination volume using the read address (step S808). The data is written according to the processing shown in FIG. 8. Thereafter, the program makes a check to determine whether or not the current address is the last address (step S805). If the address is other than the last address, the program identifies the next address (step S807) to again execute processing beginning at step S803. Otherwise, (“Y” in step S805), the source and destination volume identifiers are changed (step S806) to thereby terminate the processing. In the operation, the volume identifier of the transfer source is changed to that of the transfer destination and the volume identifier of the transfer destination is changed to that of the transfer source. It is therefore possible for the host computer to continuously issue an access request addressed to the same virtual volume.

Since the data is transferred through the processing of the access request as shown in FIG. 7, it is prevented that the segments are allocated to the storage areas of the transfer destination virtual volume.

In the processing of FIG. 8, the data read and write operations are conducted for each address. However, by use of the processor performance or a cache memory, the data read and write operations may be conducted in the unit of a plurality of addresses. If the data read and write operations are respectively conducted by different processors, the processing load is distributed to the processors and hence the overall processing speed is increased.

The data transfer processing includes two modes, namely, a first mode in which the transfer source data is deleted and a second mode in which the transfer source data is kept remained.

In the first mode, by referring to the address mapping management table 131, the program deletes data of the segment allocated to the transfer source virtual volume. Thereafter, the program deletes the segment number of the segment from the management table 131. Also, the program sets “0” to the allocation state of the segment in the pool definition management table 130. It is therefore possible to use the segment again after this point.

The processing of the storage unit has been described. Next, processing of the management server will be described.

First, each of the tables will be described.

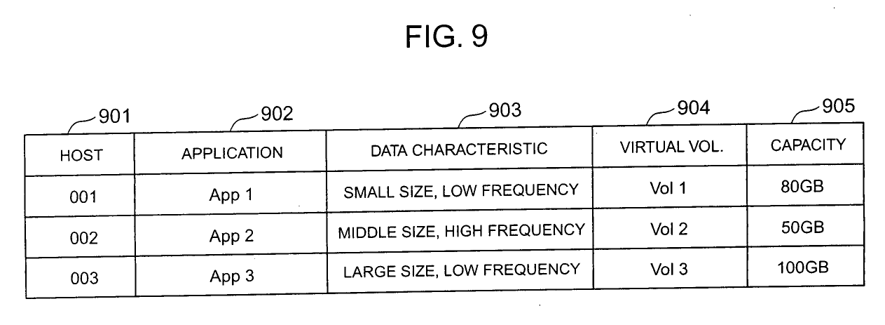

FIG. 9 shows the application management table 148.

Each entry of the table 148 includes a host identifier (ID) 901, an application 902, a data characteristic 903, a virtual volume identifier 904, and a virtual volume capacity 905. The table 148 indicates a correspondence between the application and the virtual volume and is used to define the virtual volume, which will be described later.

FIG. 10 shows the access history management table 149.

Each record of the table 149 includes a host identifier 1001, an application 1002, a virtual volume identifier 1003, an access request type 1004, a virtual volume address 1005, a data size 1006, and an access request occurrence time 1007. Access information collected from the respective host computers are set to the table 149.

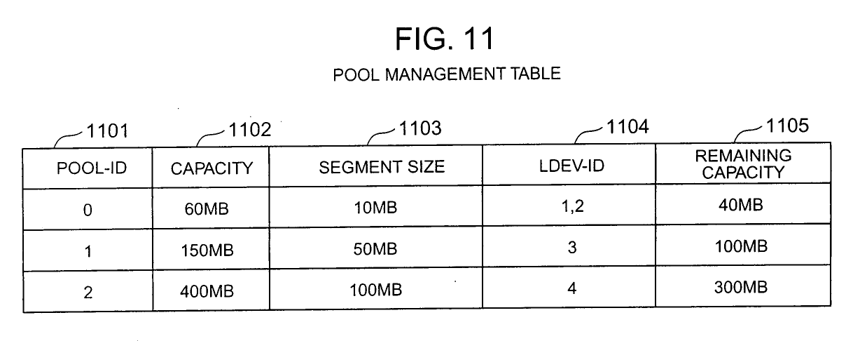

FIG. 11 shows the pool management table 150.

Each entry of the table 150 includes a pool identifier 1101, a total pool capacity 1102, a segment size 1103, an LDEV identifier 1104 of LDEV to which the associated segment belongs, and a remaining pool capacity 1105.

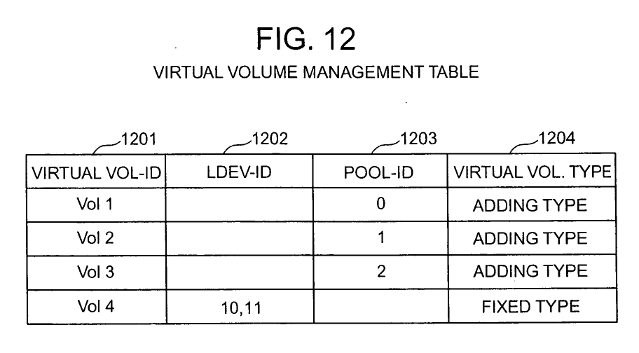

FIG. 12 shows the virtual volume management table 151.

Each record of the table 151 includes a virtual volume identifier 1201, an LDEV identifier 1202, a pool identifier 1203, and a virtual volume type 1204 indicating whether or not the associated virtual volume is of the adding or fixed type. For an additional-type virtual volume, the pool identifier field 1203 is set. For a fixed-type virtual volume, the LDEV identifier field 1202 is set.

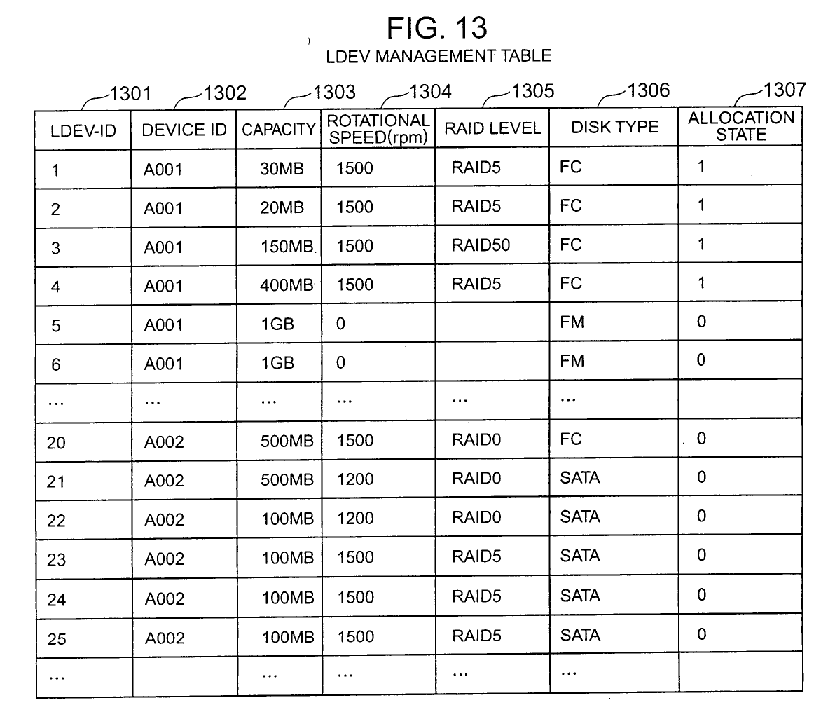

FIG. 13 shows the LDEV management table 152.

Each record of the table 152 includes an LDEV identifier 1301, a device identifier 1302, an LDEV capacity 1303, a rotational speed 1304 of the disk device as the LDEV, an RAID level 1305 configured by the disk device as the LDEV, a disk device type (disk type) 1306, and an allocation state 1307. In the disk type field 1306 of the table 152, FM indicates “flash memory”, FC is a disk for the fibre channel protocol, SATA indicates a disk for the ATA protocol. In the allocation state field 1307, “1” indicates allocation to a pool or a virtual volume. Information items set to the LDEV identifier, the capacity, the number of rotation, the RAID level, and the disk type are those collected from the respective storage units.

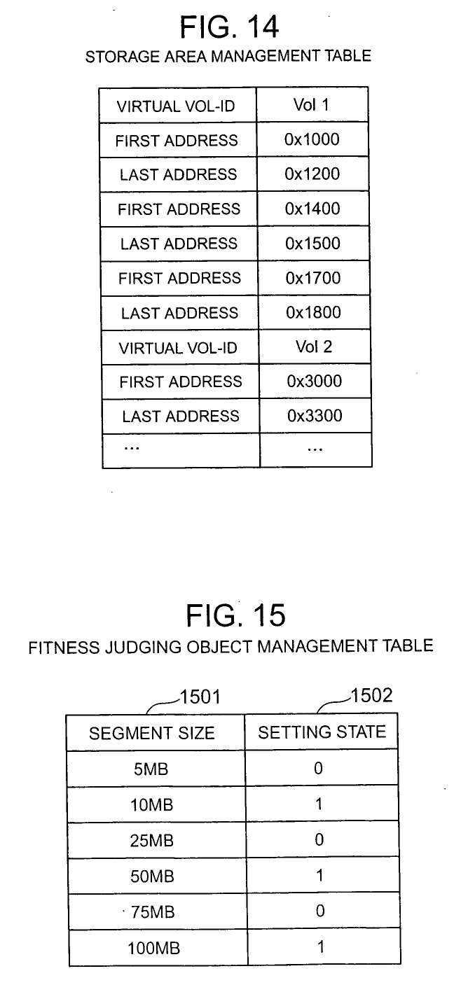

FIG. 14 shows the storage area management table 153.

The table 153 is used to manage virtual volume areas in which data has been written, and each entry thereof includes a virtual volume identifier, a first address, and a last address. The first and last addresses indicate an area in which data has been written. When data write operations are conducted at random in a virtual volume, a plurality of first addresses and a plurality of last addresses are set to the table 153.

FIG. 15 shows the fitness judging object management table 154.

Each record of the table 154 includes a segment size 1501 and a setting state 1502. In the setting state 1502, “1” indicates that the segment size is set to the storage unit and “0” indicates that the segment size is not set thereto. The state in which the segment size is not set to the storage unit indicates that the segment size is set by the manager. According to the sizes in the table 154, the program selects a segment of an appropriate segment size. It is also possible that the segment size not set to the storage unit is automatically set by the management server. For example, if two segment sizes are set to the storage unit, the management server may obtain by its CPU an intermediate segment size therebetween to set the intermediate segment size to the storage unit. Or, it is also possible that the maximum and minimum values of the data sizes of the write data are obtained from the collected information to be set as the segment sizes. Additionally, an intermediate value between the maximum and minimum values may be set as the segment size.

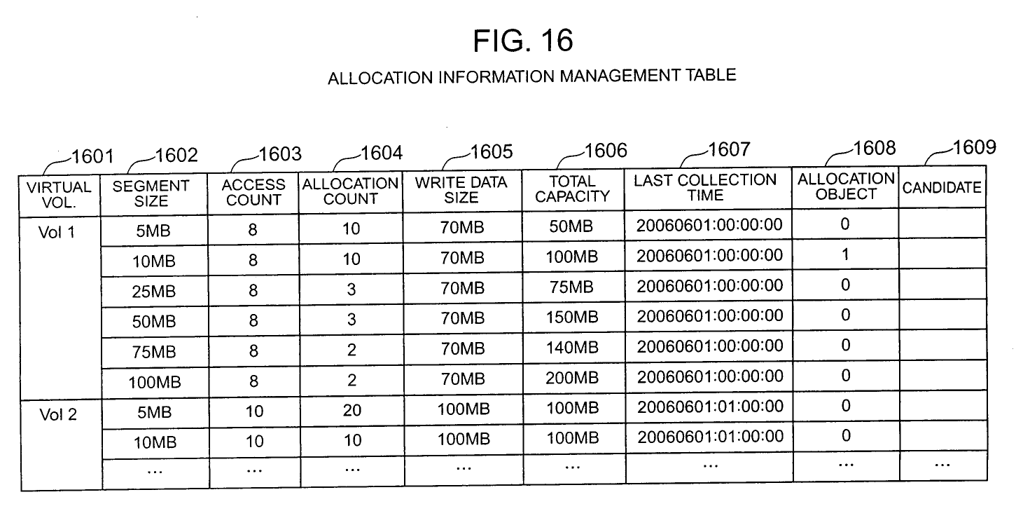

FIG. 16 shows the allocation information management table 155.

Each record of the table 155 includes a virtual volume identifier 1601, a segment size 1602, an access count 1603, a segment allocation count 1604, a write data size 1605, a total capacity of allocated segments 1606, a last collection time 1607, an allocation object 1608, and a candidate 1609. The table 155 indicates a state when the allocation is conducted according to the segment sizes which have been set to the table 155 by use of the access information. The last collection time 1607 includes information of time of the access information last used. In the allocation object 1608, “1” indicates the segment size of the segment as the current object for the virtual volume. In the candidate 1609, “1” is set when the segment size is regarded as appropriate.

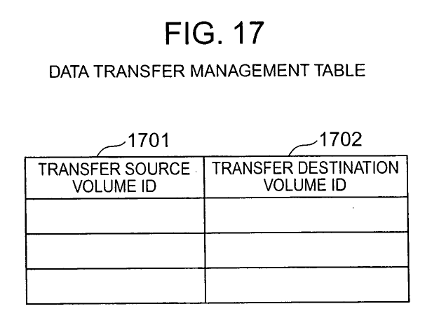

FIG. 17 shows the data transfer management table 156.

Each entry of the table 156 includes a virtual volume identifier 1701 of the transfer source volume and a virtual volume identifier 1702 of the transfer destination volume for the data transfer operation.

Description will now be given of processing of the management server.

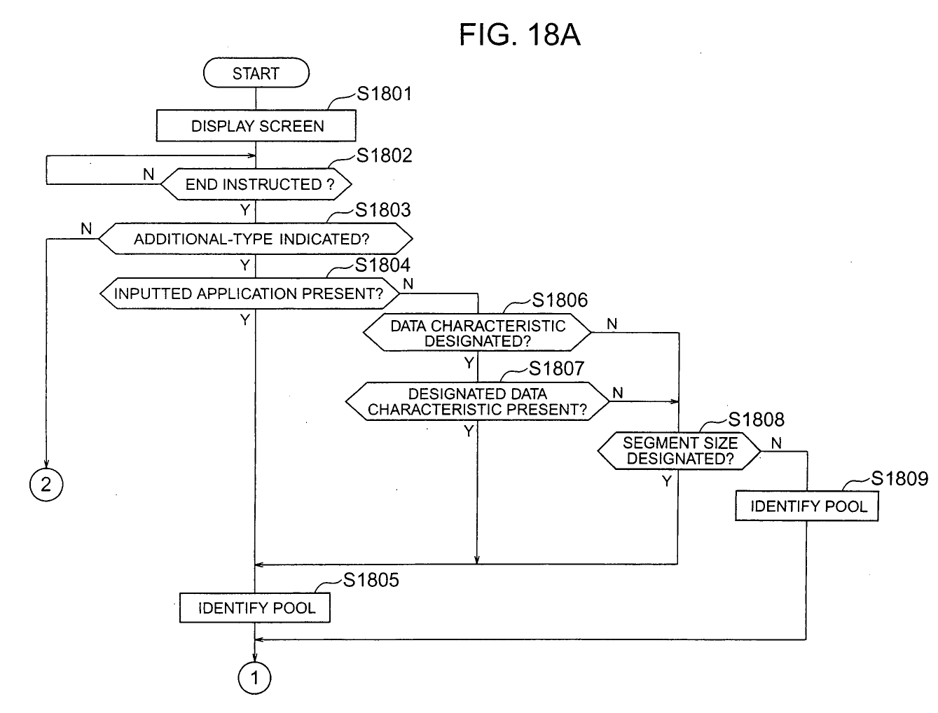

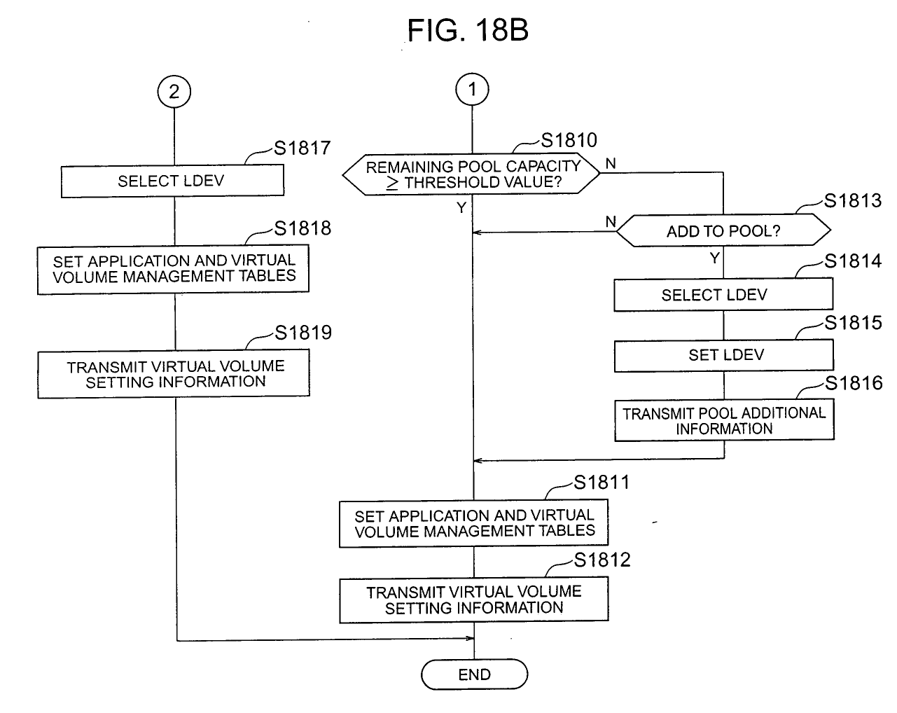

FIGS. 18A and 18B show processing to define a virtual volume.

The processing is executed when the manager instructs execution of the virtual volume definition program from the manager terminal 160.

The system displays a screen on the display of the management terminal to define a virtual volume (step S1801).

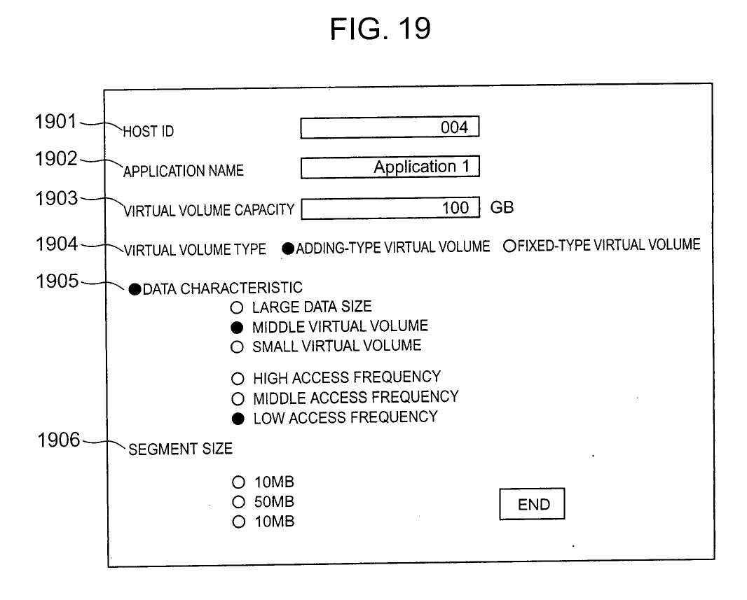

FIG. 19 shows an example of the virtual volume defining screen.

In the screen, the manager can designate a host identifier 1901, an application name 1902, a virtual volume capacity 1903, a virtual volume type 1904, a data characteristic 1905, a segment size 1906, and an end button. For the host identifier 1901 and the application name 1902, the manager inputs a host identifier and an application name which use the virtual volume. The capacity of the virtual volume is set to the virtual volume capacity 1903. The manager designates “additional-type virtual volume” or “fixed-type virtual volume” to the virtual volume type 1904. As described above, since a physical storage area is beforehand allocated to the additional-type virtual volume according to a write request, the manager can designate a relatively large capacity. If the additional-type virtual volume is specified, the data characteristic 1905 or the segment size 1906 can be specified to determine the segment size. For the data characteristic 1905, the data size to be used by the application and the application access frequency are selectable. According to the characteristic, the segment size is determined. For the segment size 1906, the program displays the segment sizes set to the pool management table 150 so that the manager selects a desired one of the segment sizes.

The processing is further described by returning to FIGS. 18A and 18B.

When the manager inputs items and designates the end button (“Y” in step S1802), the program makes a check to determine whether or not the additional-type is designated (step S1803). If the additional-type is designated, the program determines, according to the application management table 148, whether or not an application having the name of the inputted application exists in the table 148 (S1804). If the application exists in the table 148 (“Y” in step S1804), the program identifies a pool corresponding to the application by use of the table 148 and the virtual volume management table 151 (S1805). Otherwise (“N” in step S1804), a check is made to determine whether or not the data characteristic has been designated (S1806). If designated (“Y” in step S1806), the program determines whether or not information of the data characteristic is set to the table 148 (step 1807). If the information exists therein, the program identifies a pool (S1805). If the information is not set thereto (“N” in step S1806) or if the designated data characteristic is absent from the table 148 (“N” in step 1807), the program makes a check to determine whether or not a segment size is designated (S1808). If designated (“Y” in step S1808), the program identifies a pool by use of the pool management table 150 according to the designated segment size (S1805). Otherwise (“N” in step S1808), the program identifies a pool having a large remaining capacity (S1809). In the operation to identify the pool in step S1809, it is also possible to identify a pool having the smallest or largest segment size.

After the pool is identified, a check is made to determine whether or not the remaining capacity of the pool is equal to or more than the threshold value. If more than the threshold value (“Y” in step S1810), the program sets the application management table 148 and the virtual volume management table 151 (S1811). Specifically, the program generates a new virtual program identifier and sets a host identifier, an application, a data characteristic (if designated), a virtual volume identifier, and a capacity to the table 148. The program also sets a virtual volume identifier, a pool identifier, and a virtual volume type to the table 151. Next, the program sends the virtual volume defining information including the virtual volume identifier, the host identifier, the pool identifier, and the virtual volume capacity to the storage unit (step S1812) to thereby terminate the processing.

If the remaining capacity of the pool is less than the threshold value (“N” in step S1813), an inquiry message is sent to the manager to determine whether or not a pool is to be added. If the manager instructs to add a pool (“Y” in step S1813), the program selects in the LDEV management table 152 an LDEV having a characteristic substantially equal to that of the LDEV set to the pool (S1814). The program sets the LDEV and the capacity to the pool management table 150 and updates the remaining capacity (S1815). The program transmits additional pool information including the pool identifier as an additional item and the identified LDEV identifier to the storage unit (step S1816) and then control goes to processing of step S1811.

If the addition of the pool is not required (“N” in step S1813), the program goes to processing of step S1811 without adding the pool.

If the fixed type is designated (“N” in step S1803), the program selects, using the LDEV management table 152, LDEVs having the capacity equal to or more than that of the selected virtual volume (step S1817) and sets the application management table 148 and the virtual volume management table 151 (S1818). The program sends virtual volume defining information including a virtual volume identifier, a capacity, an LDEV identifier, and a host identifier to the storage unit (step S1819) to thereby terminate the processing.

When the host identifier, the pool identifier, and the virtual volume capacity from the management server 140 are received, the storage unit sets information items such as the virtual volume identifier to the pool mapping management table 129 and the address mapping management table 131.

After the storage unit sets the virtual volume definitions, the host computer sends a command to the storage unit to read information of the virtual volume set as above. When the virtual volume information (e.g., the virtual volume first and last addresses or the virtual volume capacity) is received from the storage unit, the operating system of the host computer creates a virtual volume to be provided to the application. The application and the virtual volume are then mapped. It is therefore possible for the application to access the virtual volume.

Through the processing described above, the virtual volume to be used by the application and the segment to be allocated to the virtual volume are defined.

Next, description will be given of processing in which the segment defined for a virtual volume is changed through operation of an actual application.

The access information collection program 157 of the management server 140 collects access information of each host computer at an fixed interval of time to set the information to the access history management table 149. The manager can set the interval of the period to collect the access information.

Subsequently, description will be given of processing to determine a segment of an appropriate size according to the collected access information.

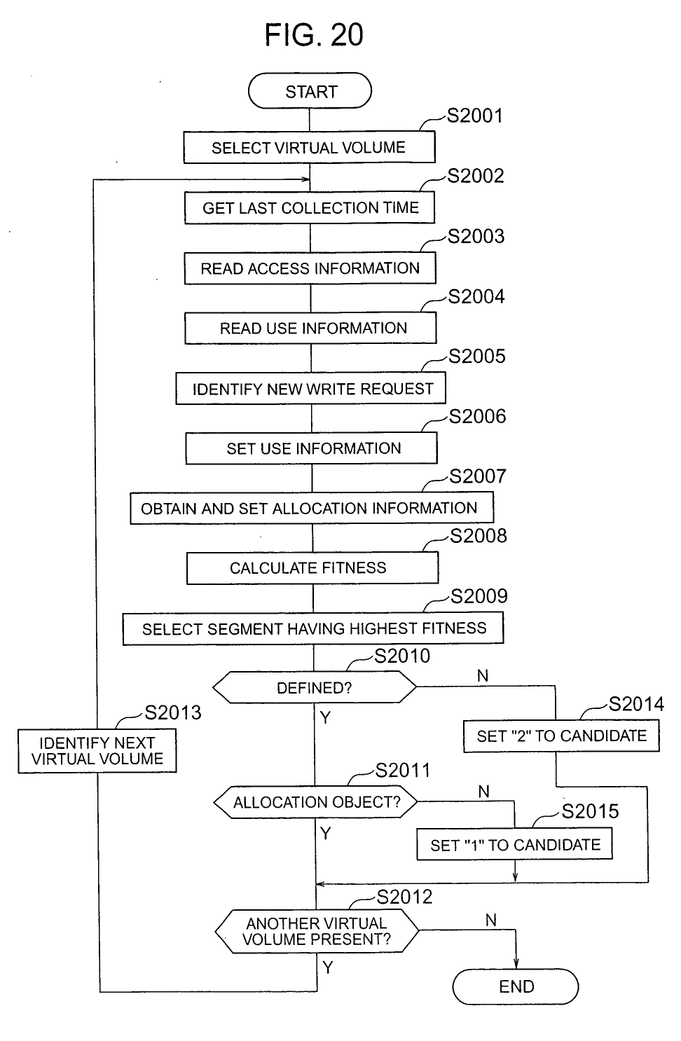

FIG. 20 shows a flow of processing to determine a segment size.

The segment determining program 144 executes the processing at a fixed interval of time.

First, the program selects an additional-type virtual volume in the virtual volume management table 151 (step S2001). The program gets the last collection time of a virtual volume selected using the allocation information management table 155 (step S2002) to read from the access history management table 149 access information created after the last collection time (step S2003). The program then reads the use information (first and last addresses) of the virtual volume from the storage area management table 153 (step S2004). According to the use information and the access information obtained in step S2003, the program identifies access information as a new write request (step S2005). The access information is access information created for a new area of the virtual volume.

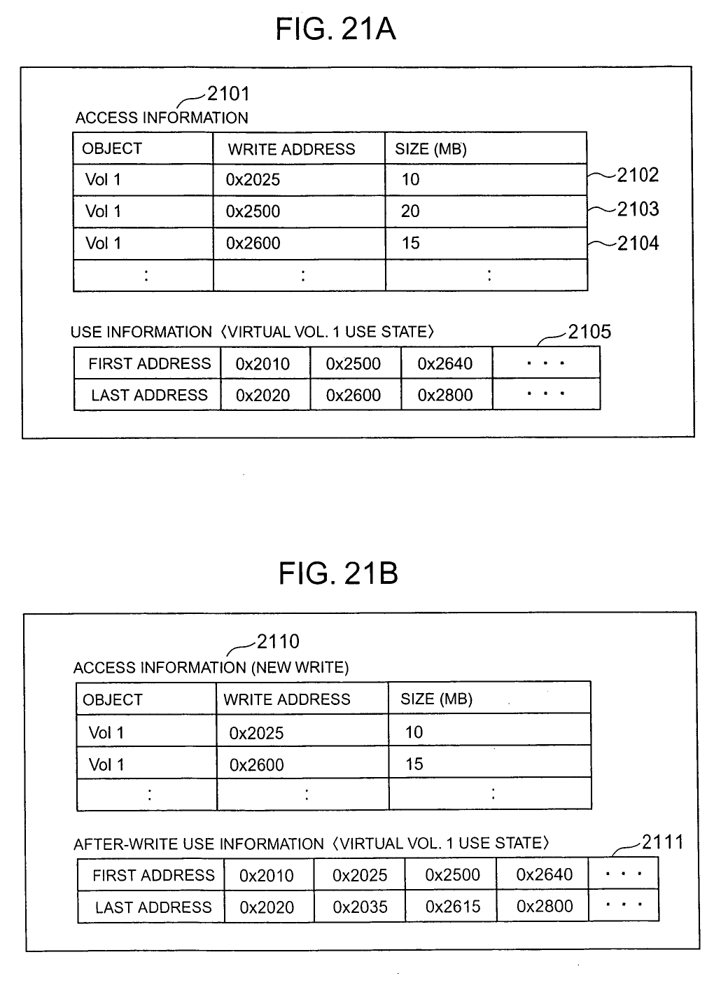

FIGS. 21A and 21B are diagrams to explain an outline of the processing to identify the access information as the new write request.

Access information 2101 of FIG. 21A shows part of the access information for volume 1 (vol1). Use information 2105 is use information for volume 1 (vol1). For areas in which data has already been written in the volume 1, the first and last addresses have been set as shown in FIG. 21A. The program compares the use information 2105 with the access information 2101 and keeps retained access information of each write request for an area not included in the range between the first and last addresses. For example, a write request with designation “write address 0x2025 and data size 10 MB” is not included in any range between the first and last addresses set as the use information and is hence kept retained to be set to the disk use management table as “first address 0x2025 and last address 0x2035” (step S2006). A write request with designation “write address 0x2500 and data size 20 MB” is included in the designated range between the first (0x2500) and last address (0x2600) set as the use information and is hence deleted.

FIG. 21B shows the result of the processing.

The program then obtains allocation information for a situation in which the allocation is conducted for the virtual volume using each segment size of the fitness judging object management table 154 and sets the information to the allocation information management table 155 (step S2007).

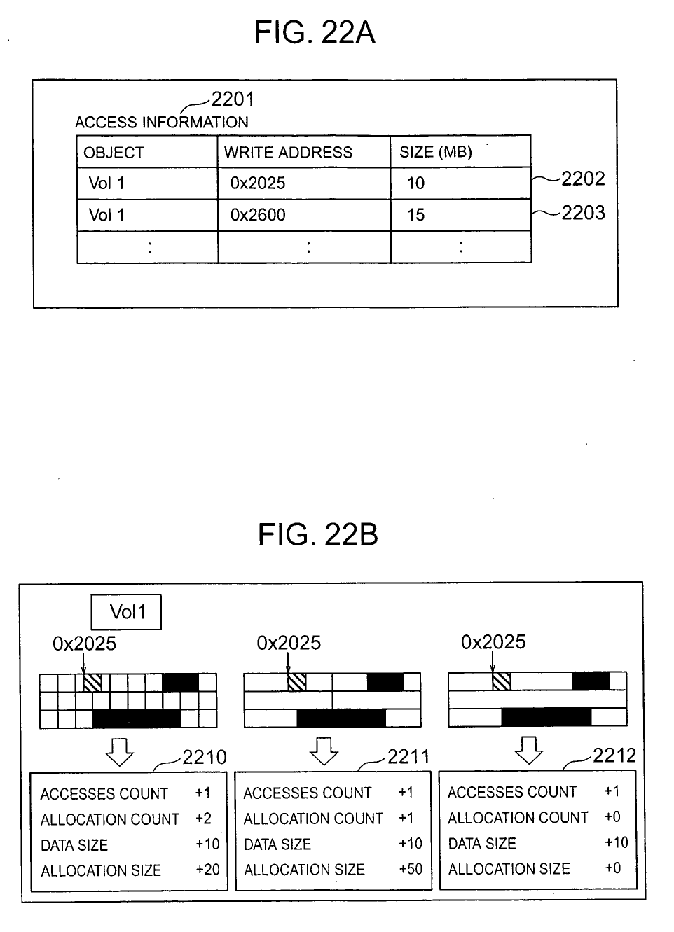

FIGS. 22A and 22B are diagrams to explain the allocation information when the allocation is conducted for the virtual volume using each segment size.

Access information 2201 shown in FIG. 22A is the result of the processing in step S2005, i.e., access information as a new write request. Although the fitness judging object management table 154 includes sizes of 5, 10, 25, 50, 75, and 100 MB, description will now be given of operation using 10, 50, and 100 MB. FIG. 22B shows a result of allocation for the write address “0x2025” and the data size “10 MB” of the access information 2201. In FIG. 22B, each black zone indicates data written therein. For the segment size of 10 MB, two segments are allocated. Resultantly, the allocation information 2210 includes “access count=1”, “allocation count=2”, “data size=10 MB”, and “allocation size=20 MB”. When the write access is conducted for the segment sizes 50 MB and 100 MB, there are created allocation information pieces 2211 and 2212, respectively. In this way, the allocation information is obtained for each segment size set to the fitness judging object management table 154.

Returning to FIG. 20, the processing will be further described.

According to the allocation information, the program obtains the fitness for each segment size (step S2008). In the embodiment, the fitness is calculated as below.

Volume utilization ratio=(write data size)/(allocated virtual volume size)

Allocation performance=(access count)/(access count+allocation count)

Fitness=(volume utilization ratio)×(allocation performance)

According to the fitness values obtained as above, the program selects a segment size having the largest fitness value (step S2009). A check is made to determine, according to the setting state of the fitness judging object management table 154, whether or not the segment of the size selected in step S2009 has been defined in the storage unit. If the segment size has been defined (“Y” in step S2010), a check is made to determine, according to the allocation object in the allocation information management table 155, whether or not the segment size has already been allocated to the virtual volume (step S2011). If “1” has already been set to the allocation object (“Y” in step S2011), the program determines, according to the virtual volume management table 151, presence or absence of another virtual volume of additional-type (step S2012). If such volume is present, the program identifies the volume (step S2013) and goes to processing in step S2002. Otherwise (“N” in step S2012), the processing is terminated.

If the segment of the size determined to have the highest fitness has not been allocated to the virtual volume (“N” in step S2011), “1” is set to the candidate field of the allocation information management table to set the segment of the size as a candidate (step S2015) and then the process goes to step S2012.

If the segment of the size determined to have the highest fitness has not been defined in the storage unit (“N” in step S2010), “2” is set to the candidate field of the table 155 (step S2014) and then the process goes to step S2012. When “2” is set to the candidate field, a segment is created, that is, a pool is created, which will be described later.

Although the fitness is the product between the volume utilization ratio and the allocation performance in step S2008, the volume utilization ratio or the allocation performance may be employed as the fitness. If the volume utilization ratio is set as the fitness, the program determines the size of a segment which leads to the minimum empty area. If the allocation performance is set as the fitness, the program determines the size of a segment which leads the least allocation count.

In the processing shown in FIG. 20, the fitness is obtained also using the allocation information in the past. However, there may be obtained the fitness during a particular period of time. Even in one application, the size of data to be used and the access frequency vary between time zones depending on cases. Therefore, it is also effective that the fitness is obtained for each time zone to change the size of the segment to be allocated, according to the time zone. For this purpose, it is only required to modify the processing as follows. In step S2003, the program asks the manager to input the start time and the end time. In step S2004, the access information between the start time and the end time is read from its storage. Since the allocation information of the past is not employed in this situation, it is not required to read the use information from its storage. As a result, the fitness of each segment and the segment as the candidate can be obtained for the designated time zone.

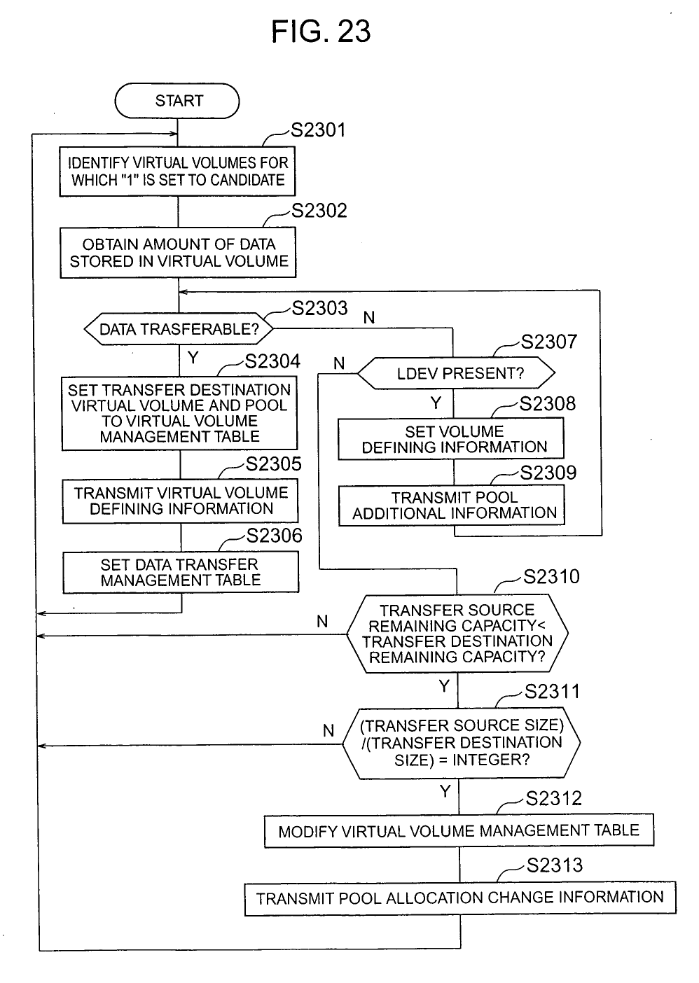

FIG. 23 shows the transfer judge processing to determine whether or not the segment is changeable to the segment of the determined size.

The processing is conducted by executing the transfer judging program 145.

First, the program identifies virtual volumes for which “1” is set to the candidate field of the allocation information management table 155 (step S2301). The program reads from the table 155 the total allocation size of the segment size for which “1” is set as above (step S2302). The program then determines whether or not the data of the identified virtual volume can be stored in the pool of the segment size as the candidate, that is, whether or not the data is transferable (step S2203). Specifically, the program determines whether or not a sufficient area can be secured in the pool even after substantially all data is transferred from the virtual volume to the pool of the segment size as the candidate. For example, the program makes a check whether or not the remainder obtained by subtracting the total allocation size from the remaining pool capacity is equal to or more than a threshold value, e.g., 50 GB. If the remainder is equal to or more than the threshold value, the program determines that the data is transferable. Otherwise, the program determines that the data is not transferable.

If it is determined that the data is transferable (“Y” in step S2303), the program generates a virtual volume identifier of a new virtual volume substantially equal in the capacity to the identified virtual volume and sets to the virtual volume management table 151 the virtual volume identifier and the pool identifier having the segment size as the candidate (step S2304). The program then sends virtual volume defining information including the virtual volume identifier, the capacity, and the pool identifier to the storage unit (step S2305). The program sets to the data transfer management table 156 the identified virtual volume as the transfer source and the new virtual volume as the transfer destination (step S2306) and then returns to the processing of step S2301.

If it is determined that the data is not transferable (“N” in step S2303), a check is made to determine whether or not an available LDEV is present in the pool as the candidate (step S2307). If such LDEV is present (“Y” in step S2307), the program sets “1” to the allocation state of the LDEV management table 152 (step S2308), sends pool additional information including a pool identifier and an LDEV identifier to the storage unit (step S2309), and returns to step S2303. If such available LDEV is absent (“N” in step S2307), the remaining capacity of the current pool is compared with that of the pool as the candidate (step S2310). If the remaining capacity of the pool as the candidate is larger, the program calculates (size of the segment of identified additional-type virtual volume)/(size of segment of the pool as candidate) to determine whether or not the resultant coefficient is an integer (step S2311). If the result is an integer (“Y” in step S2311), the program modifies the virtual volume management table 151 to allocate the segment as the candidate (step S2312), transmits pool allocation change information to the storage unit (step S2313), and then goes to step S2301. In the processing of steps S2309 to S2313, the data beforehand stored in the virtual volume is not transferred, and the new data to be stored is assigned to the segment as the candidate. As a result, segments having mutually different sizes are allocated in one virtual volume.

The processing described above is implemented on the premise that the processing is executed at a fixed interval of time. However, the processing may also be executed in response to an instruction from the manager.

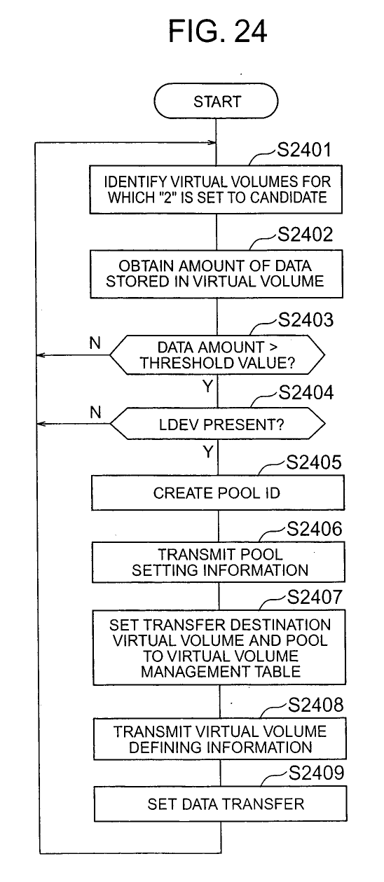

FIG. 24 shows processing to be executed when a segment of a size not defined in the storage unit is designated as the candidate.

The processing is executed by the segment creating program 146.

The program first identifies virtual volumes for which “2” is set to the candidate field of the allocation information management table 155 (step S2401) to obtain the amount of data stored in the virtual volume (step S2402). In this processing, it is assumed that the write data size of the table 155 is the amount of data stored in the virtual volume. The program then compares the amount of data with a threshold value (step 2403). If the data amount is larger, the program checks the LDEV management table 152 to determine presence or absence of an LDEV which has not been allocated and which is larger than the data amount (step S2404).

If such LDEV is present (“Y” in step S2404), the program creates a pool identifier (step S2405) and sends pool setting information including the pool identifier, a segment size, and an LDEV identifier to the storage unit (step S2406). The program also sets the pool identifier, the capacity, the segment size, and the LDEV identifier to the pool management table 150. The program then creates a virtual volume identifier of a virtual volume as the transfer destination and sets the volume identifier and the pool identifier to the virtual volume management table 151 (step S2407). To define a virtual volume as the transfer destination, the program sends virtual volume defining information (a virtual volume identifier, a pool identifier, and a capacity) to the storage unit (step S2408). Thereafter, the program sets as the transfer source the virtual volume identified in step S2401 and the new virtual volume as the transfer destination to the data transfer management table 156 (step S2409). The program returns to step S2401 to identify a virtual volume for which “2” is set to the candidate field of the allocation information management table 155 and then repeatedly executes the processing as described above.

The processing of step S2403 is employed to avoid creation of pools not frequently used. Therefore, it is also possible in step S2401 to identify a plurality of virtual volumes of the same segment size.

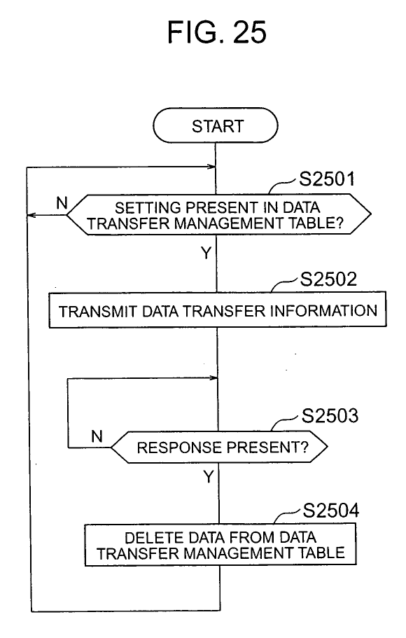

FIG. 25 shows a flow of data transfer processing.

The data transfer program 147 executes the processing.

After the processing is initiated, the program refers to the data transfer management table 156 to determine whether or not the virtual volumes of the transfer source and destination have been set (step S2501). If the volumes have been set, the program transmits data transfer information including a virtual volume identifier of the transfer source and a virtual volume identifier of the transfer destination to the storage unit (step S2502). The program awaits a response of completion of the data transfer from the storage unit (step S2503). If the data transfer is completed (“Y” in step S2503), the program deletes the virtual volume identifiers of the transfer source and destination from the data transfer management table 156 (step S2504).

As above, in use of an additional-type virtual volume when segments of different sizes are defined in the storage unit, the size of a segment allocated to the virtual volume is determined according to the access information for the virtual volume. As a result, the storage areas of the storage unit can be efficiently used.

As can be seen from the description above, it is to be understood that the size of the segment to be allocated can be determined according to a write request for the additional-type virtual volume. There exists a technique in which to restore data at a higher speed, the write data and the update information for the virtual volume are stored in a journal of the storage unit such that at occurrence of data failure, the data at a particular point of time is restored using the journal. Description will now be given of a configuration in which the size of the segment to be allocated to the additional-type virtual volume is determined using the journal.

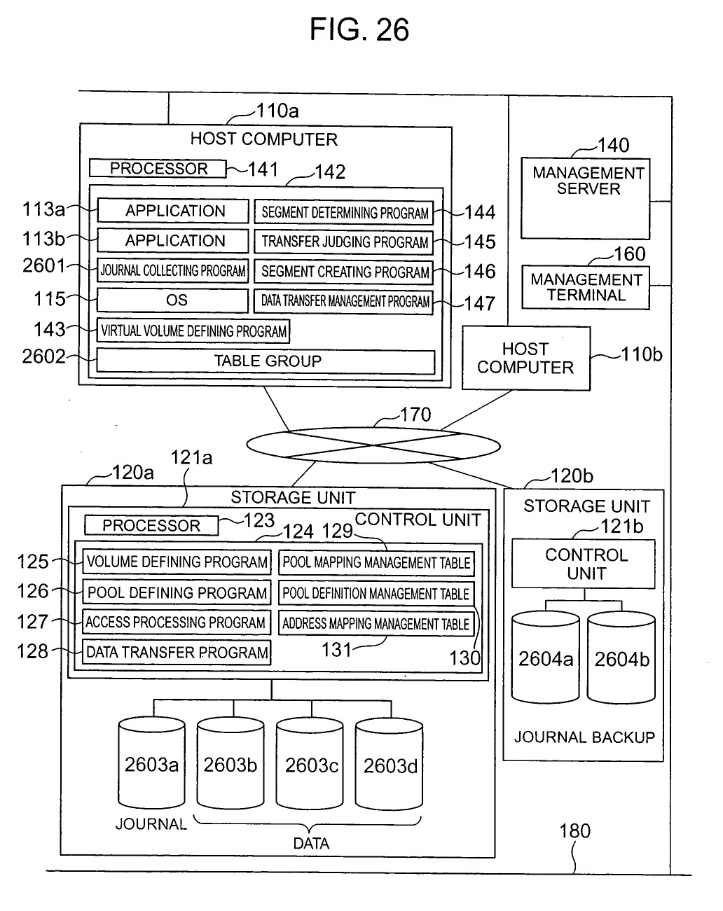

FIG. 26 shows a configuration of another embodiment of a storage system according to the present invention.

In FIG. 26, the same constituent components as those of FIG. 1 are assigned with the same reference numerals. The system of FIG. 26 differs from that of FIG. 1 in that the host computer can determine the segment size. For this purpose, the host computer 110 includes a journal collecting program 2601 in addition to the virtual volume defining program 143, the segment determining program 144, the transfer judging program 145, the segment creating program 146, and the data transfer management program 147. The host computer 110 also includes a group of tables 2602 having stored information items to be used by the respective programs. The storage unit 120a includes a control unit or controller 121a and volumes 2603 to store data. The volumes include volumes 2603b, 2603c, and 2603d (additional-type) to store data of applications and a journal volume 2603a (fixed type) to store journal data for data volumes. The journal or journal data includes write data and update information for a virtual volume. The update information is information to manage write data for the virtual volume and includes a time of reception of the write request, a volume as an object of the write request, a logical address of the volume as the write request object, and a data size of the write data. The journal is stored in the journal volume 2603a in step S703 of FIG. 7. That is, data is stored in the data volume and the journal is stored in the journal volume.

The storage unit 120b includes a control unit 121b and a journal volume 2604a to store a journal data copy of the journal data stored in the storage unit 120a.

In the configuration, the host computer 110a reads by the journal collecting program 2601 the journal from the journal volume. The operation to read the journal from the journal volume 2603a is almost the same as the operation to read data from the data volumes 2603b and 2603c. The update information of the journal is stored as access information in the access history management table of the host computer 110. Therefore, by use of the segment determining program 144, the transfer judging program 145, the segment creating program 146, and the data transfer management program 147, the size of the segment to be allocated can be determined, the data can be transferred, and segments of a new size can be defined in the storage unit.

It should be further understood by those skilled in the art that although the foregoing description has been made on embodiments of the invention, the invention is not limited thereto and various changes and modifications may be made without departing from the spirit of the invention and the scope of the appended claims.

1. A storage system, comprising:
a storage unit having a plurality of storage areas of mutually different sizes, and a control unit which includes correspondence information indicating a correspondence between virtual storage areas and the sizes of the storage areas to be allocated to the virtual storage areas, the control unit referring to correspondence information in response to a write request for one of the virtual storage areas, allocating one of the storage areas to the virtual storage area, and storing data of the write request in the storage area thus allocated; and
a management server for collecting write requests from a host computer occurring for the virtual storage areas during a period of time, selecting a size of the storage area from the sizes of the storage areas by use of a size of data contained in each of the write requests thus collected, the storage area being allocated to the virtual storage area, and transmitting to the storage unit a request to change the correspondence information to thereby allocate the storage area of the size thus selected to the virtual storage area.

2. A storage system according to claim 1, wherein the size of the storage area is less than the size of the virtual storage area.

3. A storage system according to claim 1, wherein the management server sends a request to the storage unit when a change occurs in the correspondence information, the request moving data stored before the change in the correspondence information in the storage area allocated to the virtual storage area, to one of the storage areas of a size corresponding to the virtual storage area according to the correspondence information after the change.

4. A storage unit comprising:
a plurality of storage areas for storing data therein; and
a control unit for creating a plurality of partition areas by dividing at least one of the storage areas into partition areas of mutually different sizes, comprising correspondence information indicating a correspondence between virtual storage areas and the sizes of the partition areas to be allocated to the virtual storage areas, and referring to correspondence information in response to a write request for one of the virtual storage areas, allocating one of the partition areas to the virtual storage area, and storing data of the write request in the partition area thus allocated.

5. A storage unit according to claim 4, wherein the control unit stores the write request in one of the storage areas, the storage area not being divided into partition areas.

6. A storage unit according to claim 5, wherein the storage unit selects, by use of a size of data contained in a write request during a period of time stored in one of the storage areas, a size of the partition area to be allocated to the virtual storage area from the sizes of the plural partition areas of mutually different sizes, and changes the correspondence information to allocate the partition area of the size thus selected to the virtual storage area.

7. A storage unit according to claim 6, wherein the control unit creates new partition areas using one of the plural storage areas when a total amount of the partition areas having the size thus selected and being not allocated to the virtual storage areas is equal to or less than a threshold value.

8. A storage unit according to claim 5, wherein the control unit reads, in response to a read request for one of the virtual storage areas, data from one of the partition areas allocated to an address of the virtual storage area designated by the read request, and returns an error message in response to the read request if the partition area has not been allocated to the virtual storage area designated by the read request.

9. A storage unit according to claim 5, wherein the control unit issues a read request for the virtual storage area, and issues, if data is read therefrom according to the read request, a write request of the data to other one of the virtual storage areas.

10. A storage area allocation control method, comprising the steps of:
collecting write requests occurring for virtual storage areas during a period of time;
selecting, by use of a size of data contained in each of the write requests thus collected, one of the sizes of storage areas having mutually different sizes of a storage unit, the size being allocated to the virtual storage area of the write request; and
transmitting to the storage unit a request to allocate the storage area of the size thus selected to the virtual storage area.

11. A storage area allocation control method according to claim 10, further comprising the step of selecting the storage area of a size, the size making it possible that when the storage area of the size is allocated to the virtual storage area, the number of allocation of the storage area to the virtual area becomes smaller.

12. A storage area allocation control method according to claim 10, further comprising the step of selecting the storage area of a size, the size making it possible that when the storage area of the size is allocated to the virtual storage area, a capacity of an empty area of the storage area allocated to the virtual area becomes smaller.

13. A storage system, comprising:
a storage unit having a plurality of storage areas for storing data therein, and a control unit for dividing at least one of the storage areas and thereby defining a plurality of partition areas of a first size and a plurality of partition areas of a second size, comprising correspondence information indicating a correspondence between virtual storage areas and the sizes of the partition areas to be allocated to the virtual storage areas, and referring to correspondence information in response to a write request for one of the virtual storage areas, allocating one of the partition areas to the virtual storage area, and storing data of the write request in the partition area thus allocated; and
a management server for collecting, write requests from a host computer occurring for the virtual storage areas during a period of time, selecting a partition area from the partition areas of the first size and the partition areas of the second size by use of a size of data contained in each of the write requests thus collected, the partition area being allocated to the virtual storage area, and transmitting to the storage unit a request to change the correspondence information to thereby allocate the partition area thus selected to the virtual storage area.

14. A storage system according to claim 13, wherein the size of the partition area is less than a size of the virtual storage area.

15. A storage system according to claim 13, wherein the management server sends a request to the storage unit when a change occurs in the correspondence information, the request moving data stored before the change in the correspondence information in the partition area allocated to the virtual storage area, to one of the partition areas of a size corresponding to the virtual storage area according to the correspondence information after the change.
